(19) United States
(12) Patent Application Publication
(10) Pub. No.: US 2026/0057005 A1
(43) Pub. Date: Feb. 26, 2026

(54) BIBLIOGRAPHICAL METADATA GENERATION

(71) Applicant: Camelot UK Bidco Limited, London (GB)

(72) Inventors: Lei SONG, Lancaster, PA (US); Hongliang LIU, Menlo Park, CA (US); David HANEGBI, Jerusalem (IL)

(21) Appl. No.: 19/307,230

(22) Filed: Aug. 22, 2025

Related U.S. Application Data
(60) Provisional application No. 63/686,619, filed on Aug. 23, 2024.

(51) Int. Cl. G06F 16/248

(52) U.S. Cl. CPC G06F 16/383; G06F 16/313

(57) ABSTRACT

System, methods, apparatuses, and computer program products are disclosed for generating bibliographical metadata using a machine learning model. At least a portion of a textual work is provided as input to the machine learning model. The machine learning model returns a summary of the textual work and a set of subject headings associated with a subject of the textual work. The subject headings are validated by mapping the subject headings provided by machine learning model to second subject headings that satisfy a similarity threshold to the subject headings provided by machine learning model. The second subject headings are ranked based on the summary. Bibliographical metadata is generated based at least on a subset of the second subject headings that satisfy a rank threshold.

### CROSS-REFERENCE TO RELATED APPLICATIONS

This application claims priority to U.S. Provisional Patent Application No. 63/686,619, entitled “BIBLIOGRAPHICAL METADATA GENERATION,” and filed on Aug. 23, 2024, now pending, the entirety of which is incorporated herein by reference.

### BACKGROUND

Bibliographical metadata enables efficient organization, discovery, and retrieval of materials within a library system. This metadata typically includes information such as a title, an author, a publisher, publication date, a classification, a subject, and the like. To facilitate the exchange and sharing of cataloging data, standardized formats have been developed for encoding bibliographical information. As new works are created and added to library systems, bibliographical metadata needs to be generated for the new works to facilitate their discovery, and retrieval.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

System, methods, apparatuses, and computer program products are disclosed for generating bibliographical metadata using a machine learning model. At least a portion of a textual work is provided as input to the machine learning model. The machine learning model returns a summary of the textual work and a set of subject headings associated with a subject of the textual work. The subject headings are validated by mapping the subject headings provided by machine learning model to second subject headings that satisfy a similarity threshold to the subject headings provided by machine learning model. The second subject headings are ranked based on the summary. Bibliographical metadata is generated based at least on a subset of the second subject headings that satisfy a rank threshold.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for generating bibliographical metadata using a machine learning model, in accordance with an embodiment.

FIG. 2 depicts a block diagram of an example system for validating bibliographical metadata generated by a machine learning model, in accordance with an embodiment.

FIG. 3 depicts a flowchart of a process for validating bibliographical metadata generated by a machine learning model, in accordance with an embodiment.

FIG. 4 depicts a flowchart of a process for validating subject headings generated by a machine learning model, in accordance with an embodiment.

FIG. 5 depicts a flowchart of a process for generating bibliographical metadata, in accordance with an embodiment.

FIG. 6 depicts a flowchart of a process for generating bibliographical metadata, in accordance with an embodiment.

FIG. 7 depicts a flowchart of a process for updating a updating a library catalog, in accordance with an embodiment.

FIG. 8 depicts a flowchart of a process for incorporating bibliographical metadata in a content file, in accordance with an embodiment.

FIG. 9 depicts a flowchart of a process for performing a search based on bibliographical metadata, in accordance with an embodiment.

FIG. 10 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

As used herein, the term “textual work” refers to a textual portion of content that comprises written language. In embodiments, textual works include, but are not limited to, books, novels, articles, essays, poems, scripts, letters, diaries, reports, studies, digital content, and/or the like.

As used herein, the term “bibliographical metadata” refers to information that describes a textual work. In embodiments, bibliographical metadata includes, but is not limited to, a title, an author, a publication date, a publisher, an international standard book number (ISBN), an international standard serial number (ISSN), an edition, a language, one or more subject headings, a Dewey decimal classification (DDC), a Library of Congress classification (LCC), a summary, an abstract, and/or the like. In embodiments, bibliographical metadata comprise metadata fields of a catalog standard, including, but not limited to, MARC (machine-readable cataloging), MARC 21, MARCXML, and/or the like.

As used herein, the term “machine learning model” refers to a computational system or algorithm that is trained to identify patterns and relationships from a training dataset, and make classification and/or prediction decisions based on the training.

As used herein, the term “large language model” refers to a machine learning model trained on a large corpus of content to process and generate human language that mimics human-like communication.

As used herein, the term “embedding model” refers to a machine learning model that processes high-dimensional input data (e.g., text, images, etc.) and outputs a lower-dimensional vector that is representative of the input data.

As used herein, the term “similarity model” refers to a machine learning model that determines a degree of similarity between two or more items. In embodiments, a similarity model includes, but is not limited to, a clustering model, a k-nearest neighbor (k-NN) classification model, an approximate nearest neighbor (ANN) model, and/or the like.

### II. Example Embodiments

Bibliographical metadata enables efficient organization, discovery, and retrieval of materials within a library system. To facilitate the exchange and sharing of cataloging data, standardized formats have been developed for encoding bibliographical information. As new works are created and added to library systems, bibliographical metadata needs to be generated for the standardized format new works to facilitate their discovery, and retrieval.

Generating bibliographical metadata for new and existing works is a highly complex endeavor that requires highly specialized knowledge in library cataloging. For instance, classifying a work into a library classification system (e.g., DDC, LCC, etc.) typically requires reading and/or analyzing the work to determine the type of work, the topic or subject of the work, and/or the like. This process is further complicated by the size and complexity of library classification vocabularies, such as, the Library of Congress Subject Headings (LCSH).

Improvements in artificial intelligence (AI) have resulted in machine learning models, such as, but not limited to, large language models (LLMs), that are capable of classifying information with a high degree of accuracy. However, such machine learning models are susceptible to returning inaccurate, misleading, or fabricated output at times. Embodiments disclosed herein are directed to systems, methods, and computer program products for generating accurate bibliographical metadata in an automated and scalable manner using machine learning models.

In embodiments, generating bibliographical metadata for a textual work involves providing at least a portion of the textual work to a machine learning model, such as, but not limited to, an LLM. For instance, an LLM is provided with a prompt requesting bibliographical metadata for the textual work along with at least a portion of the textual work, including, but not limited to, one or more chapters of the textual work, a predetermined number of pages of the textual work, an entirety of the textual work, and/or the like. An exemplary prompt may include the following request: “Please provide a summary, a type (e.g., fiction, non-fiction), a language, a Dewey decimal classification, a library of congress classification, and library of congress subject headings for the following text,” along with the portion of the textual work.

In embodiments, the bibliographical metadata provided by the machine learning model is post-processed to ensure accuracy and/or compliance with cataloging standards, such as, but not limited to, DDC, LCC, LCSH, etc. The processed bibliographical metadata is, in embodiments, combined with other known bibliographical metadata (e.g., title, author, etc.), and/or bibliographical metadata obtained from other sources or generated through other techniques. In embodiments, the combined bibliographical metadata is aggregated in a standardized format (e.g., MARC, MARCXML, etc.).

The accuracy of the bibliographical metadata provided by the machine learning model varies based on the type of bibliographical metadata. In embodiments, post-processing of the bibliographical metadata provided by the machine learning model depends on the type of bibliographical metadata. For instance, certain metadata, such as, but not limited to, the language, the type, the DDC, the LCC, and/or the like, are of sufficient accuracy that no post-processing is required. In contrast, other metadata, such as, but not limited to, LCSH and/or the like, are more susceptible to hallucinations and require additional verification.

In embodiments, subject headings provided by the machine learning model are verified against a standardized library vocabulary, such as, but not limited to, the LCSH. For instance, subject headings provided by the machine learning model are mapped to the LCSH using a similarity model (e.g., ANN model, k-NN model, etc.) based on embedding vectors generated using an embedding model. In embodiments, the embedding model generates first embedding vectors for the subject headings provided by the machine learning model and second embedding vectors for the LCSH subject headings. In embodiments, the second embedding vectors for the LCSH subject headings are generated once and stored for future use. In embodiments, the subject headings provided by the machine learning model are mapped to LCSH using a similarity model that determines a distance between the first embedding vectors and one or more of the second embedding vectors.

After mapping the subject headings provided by the machine learning model to the LCSH, in embodiments, the LCSH subject headings corresponding to the subject headings provided by the machine learning model are ranked using a machine learning model (e.g., LLM, etc.) based on the summary previously provided by the machine learning model. For example, an exemplary follow-up prompt may include the following request: “Please rank the following subject headings based on the summary,” along with a list of the LCSH subject headings. In embodiments, the ranked list returned by the machine learning model is filtered using a rank threshold (e.g., top 2 or top 3 subject headings, etc.), and the subject headings satisfying the rank threshold are included in the output bibliographical metadata file (e.g., MARC, MARCXML, etc.).

In embodiments, the output bibliographical metadata file is generated by aggregating bibliographical metadata from various sources. For instance, some bibliographical metadata (e.g., title, author, publication year, table of contents, etc.) is extracted directly from the textual work and incorporated into the output bibliographical metadata file with minimal changes (e.g., formatting, mark-up, etc.). In embodiments, some bibliographical metadata (e.g., language, fiction/non-fiction, DDC, LCC, etc.) is provided by a machine learning model, as discussed above, and incorporated into the output bibliographical metadata file with minimal to no changes (e.g., formatting, mark-up, etc.). In embodiments, other bibliographical metadata (e.g., summary, etc.) provided by a machine learning model, as discussed above, and incorporated into the output bibliographical metadata file with more substantial changes (e.g., condensing for brevity, etc.). In embodiments, other bibliographical metadata (e.g., subject headings, etc.) provided by a machine learning model, as discussed above, are verified prior to incorporating into the output bibliographical metadata file.

These and further embodiments are disclosed herein that enable the functionality described above and additional functionality. Such embodiments are described in further detail as follows.

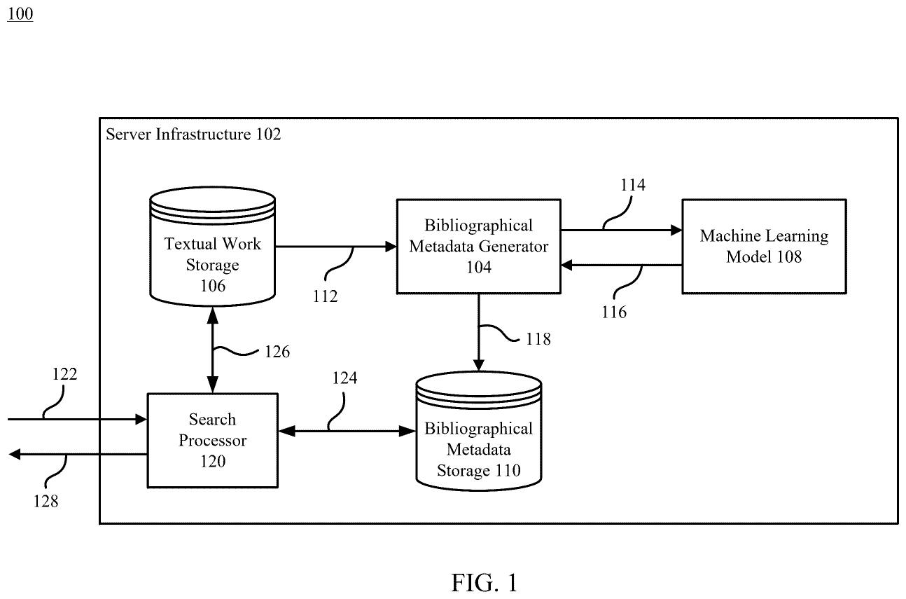

For instance, FIG. 1 depicts a block diagram of an example system 100 for generating bibliographical metadata using a machine learning model, in accordance with an embodiment. As shown in FIG. 1, system 100 includes a server infrastructure 102 that includes a bibliographical metadata generator 104, a textual work storage 106, a machine learning model 108, a bibliographical metadata storage 110, and a search processor 120. System 100 is described in further detail as follows.

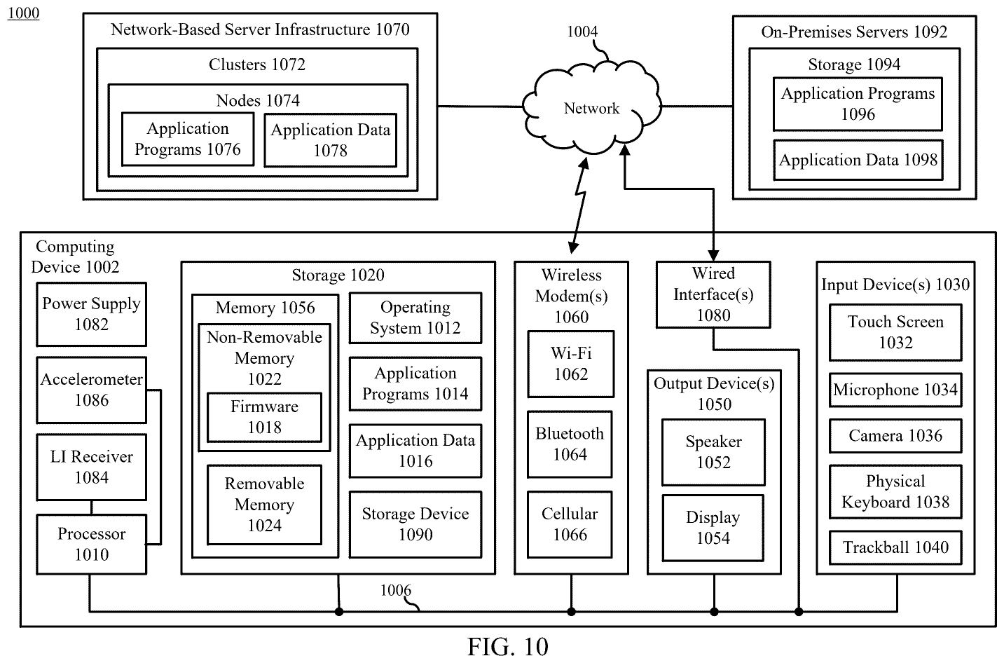

Server infrastructure 102 may comprise a network-accessible server set (e.g., cloud-based environment or platform). In an embodiment, the underlying resources of server infrastructure 102 are co-located (e.g., housed in one or more nearby buildings with associated components such as backup power supplies, redundant data communications, environmental controls, etc.) to form a datacenter, are distributed across different regions, and/or are arranged in other manners. Various example implementations of server infrastructure 102 are described below in reference to FIG. 10 (e.g., network-based server infrastructure 1070, and/or components thereof).

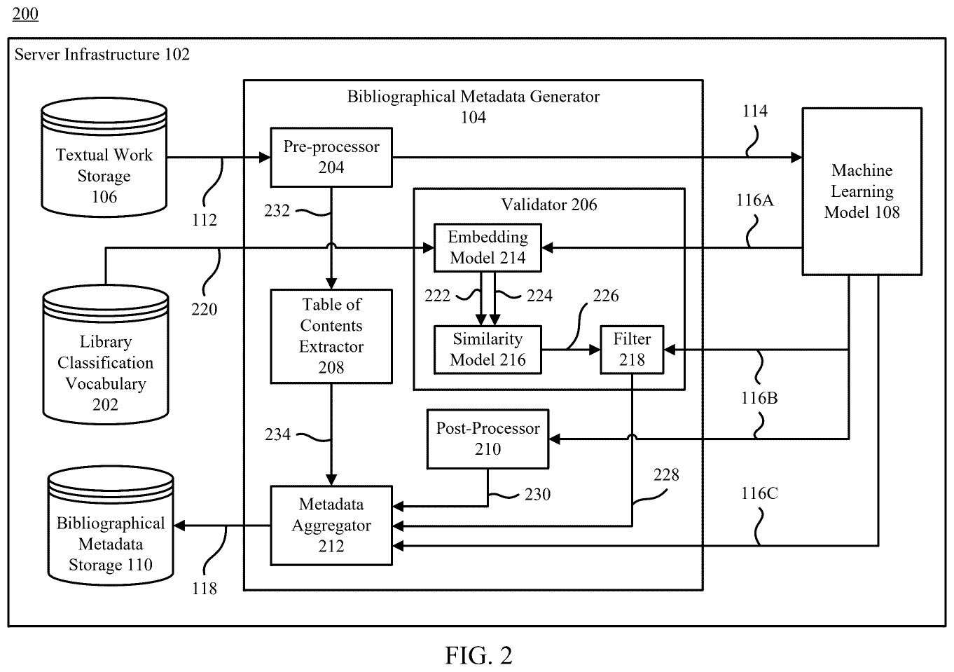

Bibliographical metadata generator 104 is configured to receive at least a portion of a textual work 112 from textual work storage 106, provide a prompt 114 to machine learning model 108 to request bibliographical metadata 116 therefrom, generate output bibliographical metadata 118 based at least on bibliographical metadata 116 received from machine learning model 108. In embodiments, bibliographical metadata generator 104 provides output bibliographical metadata 118 to bibliographical metadata storage 110 for storage thereon. Bibliographical metadata generator 104 will be discussed in greater detail below in conjunction with FIG. 2.

Textual work storage 106 stores one or more textual works, such as, but not limited to, books, novels, articles, essays, poems, scripts, letters, diaries, reports, studies, digital content, and/or the like.

Machine learning model 108 is configured to receive a natural language prompt 114, process prompt 114, and return a response to 116 generated based on prompt 114. In embodiments, machine learning model 108 includes, but is not limited to, a commercially available LLM, an LLM augmented with specialized knowledge for generating bibliographical metadata, and/or the like. For instance, an LLM is augmented by providing the LLM with a textual information on how to generate bibliographical metadata.

Bibliographical metadata storage 110 stores output bibliographical metadata 118 generated by bibliographical metadata generator 104. In embodiments, bibliographical metadata storage 110 comprises a relational database that facilitates the discovery and/or retrieval of textual works associated with output bibliographical metadata 118.

Search processor 120 is configured to receive a search request 122, perform a search, and return a search result 128. In embodiments, search processor 120 parses search request 122 to extract a search criteria (e.g., search string, metadata field, metadata value, etc.) from search request 122, and searches bibliographical metadata storage 110 based on the extracted search criteria. Search processor 120 performs search 124 against bibliographical metadata storage 110 and/or a search 126 against textual work storage 106 to determine a content item that satisfies the search criteria by, for example, by not limited to, determining a matching record that includes a bibliographical metadata field that satisfies the search criteria, determining record that includes text that satisfies the search criteria, determining a file that includes bibliographical metadata that satisfies the search criteria, and/or the like. Search processor 120 returns search result 128 that contains a matching record from bibliographic metadata storage 110 and/or a matching file from textual work storage 106.

Embodiments described herein may operate in various ways to validate bibliographical metadata generated by a machine learning model. For example, FIG. 2 depicts a block diagram of an example system 200 for validating bibliographical metadata generated by a machine learning model, in accordance with an embodiment. As shown in FIG. 2, system 200 includes server infrastructure 102, bibliographical metadata generator 104, textual work storage 106, machine learning model 108, and bibliographical metadata storage 110. Moreover, in system 200, server infrastructure 102 further includes a library classification vocabular 202, and bibliographical metadata generator 104 further includes a pre-processor 204, a validator 206, a table of contents extractor 208, a post-processor 210, and a metadata aggregator 212. Additionally, validator 206 further includes an embedding model 214, a similarity model 216, and a filter 218. System 200 is described in further detail as follows.

Library classification vocabulary 202 comprises a controlled vocabulary of subject headings associated with a standardized library classification system, such as, but not limited to, LCSH, and/or the like. In embodiments, library classification vocabulary 202 comprises a data structure (e.g., list, tree, graph etc.) that stores subject headings associated with the standardized library classification system. In embodiments, the subject headings associated with a standardized library classification system is organized in a hierarchical data structure.

Pre-processor 204 is configured to access textual work 112 from textual work storage 106, and extract portions of text from textual work 112. In embodiments, pre-processor 204 provides, to machine learning model 108, a prompt requesting bibliographical metadata along with at least a portion of textual work 112, such as, but not limited to, a predetermined number of chapters, a predetermined number of pages, and/or the like. In embodiments, pre-processor 204 extracts a portion 232 of textual work 112, and provides portion 232 to table of contents extractor 208. In embodiments, portion 232 includes, but is not limited to, a predetermined number of page from the beginning of textual work 112, pages prior to the first chapter of textual work 112, the entirety of textual work 112, and/or the like.

Validator 206 is configured to validate first subject headings 116A provided by machine learning model 108. In embodiments, validator 206 maps first subject headings 116A to second subject headings 226 using similarity model 216. For instance, validator 206 employs embedding model 214 to generate first embedding vectors 224 representative of first subject headings 116A and second embedding vectors 222 representative of standardized subject headings 220 in library classification vocabulary 202, and employs similarity model 216 to determine second embedding vectors 222 that satisfy a similarity threshold with first embedding vectors 224. In embodiments, second subject headings 226 corresponding to second embedding vectors 222 that satisfy the similarity threshold with first embedding vectors 224 are provided to filter 218. In embodiments filter 218 ranks second subject headings 226 based on their relevancy to summary 116B, and provides the highest ranking subject headings 226 to metadata aggregator 212 as filtered subject headings 228.

Table of contents extractor 208 is configured to receive portion 232 from pre-processor 204, and determine a table of contents from portion 232. In embodiments, table of contents extractor 208 detects the presence of a table of contents by, for example, but not limited to, detecting a table of contents heading, detecting chapter or section headings in proximity to page numbers, and/or the like. Responsive to detecting a table of contents, table of contents extractor 208, in embodiments, extracts a table of contents 234 from portion 232. When a table of contents is not detected, table of contents extractor 208, in embodiments, generates table of contents 234 by extracting, from portion 232 of textual work 112, chapter or section headings and the corresponding page numbers on which the chapter or section headings appear. In embodiments, table of contents extractor 208 provides table of contents 234 to metadata aggregator 212 for inclusion in output bibliographical metadata 118.

Post-processor 210 is configured to perform post processing on summary 116B provided by machine learning model 108. For instance, post-processor 210, in embodiments, condenses summary 116B to generate a brief summary 230. In embodiments, post-processor 210 provides brief summary 230 to metadata aggregator 212 for inclusion in output bibliographical metadata 118.

Metadata Aggregator 212 is configured to aggregate bibliographical metadata from various sources, generate output bibliographical metadata 118, and provide output bibliographical metadata 118 to bibliographical metadata storage 110 for storage thereon. In embodiments, metadata aggregator 212 generates output bibliographical metadata 118 in a standardized bibliographical metadata format, such as, but not limited to, MARC, MARCXML, and/or the like.

Embedding model 214 is configured to generate first embedding vectors 224 and second embedding vectors 222 that are lower-dimensional representations of first subject headings 116A and standardized subject headings 220, respectively, that capture semantic relationships present in first subject headings 116A and standardized subject headings 220. In embodiments, embedding model 214, includes, but is not limited to, a word embedding model (e.g., word2Vec, BERT, GloVe, FastText, etc.), a sentence embedding model (e.g., sentence-BERT, Universal Sentence Encoder, etc.), and/or the like.

Similarity model 216 is configured to quantify a degree of similarity between first embedding vectors 224 representative of first subject headings 116A and second embedding vectors 222 representative of standardized subject headings 220. In embodiments, similarity model 216 determines a degree of similarity based on a distance (e.g., Euclidean distance, cosine distance, etc.) between first embedding vectors 224 and one or more second embedding vectors 222, and returns second subject headings 226 associated with the second embedding vectors 222 having the highest degree of similarity or the shortest distance to first embedding vectors 224. In embodiments, similarity model 216 implements an ANN algorithm, a k-NN algorithm, or an approximate k-NN algorithm.

Filter 218 is configured to rank second subject headings 226 based on a relevancy to summary 116B, and determine the highest ranking second subject headings 226 that satisfy a rank threshold (e.g., top 2 or top 3 subject headings). In embodiments, filter 218 ranks second subject headings 226 based on summary 116B by providing a follow-up prompt (not shown) along with second subject headings 226 to machine learning model 108 requesting a ranking of second subject headings 226 based on summary 116B previously provided by machine learning model 108. In embodiments, the follow-up prompt also incorporates summary 116B in the prompt itself.

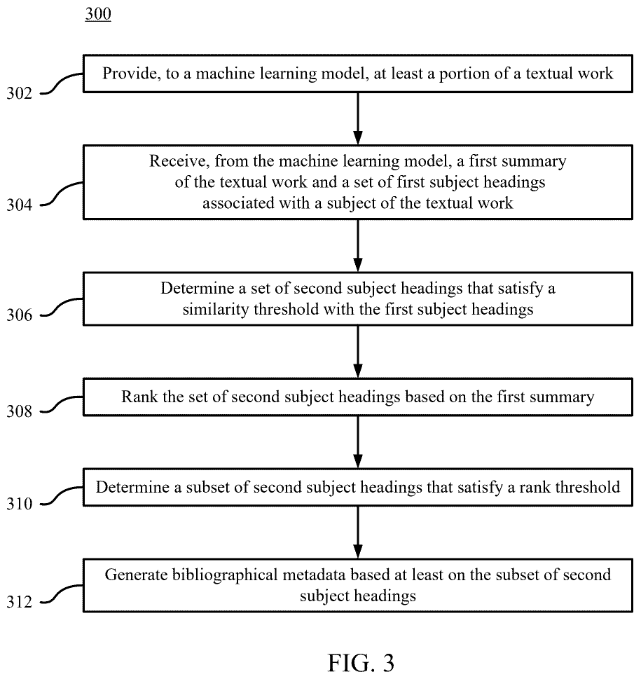

Embodiments described herein may operate in various ways to validate bibliographical metadata generated by a machine learning model. FIG. 3 depicts a flowchart 300 of a process for validating bibliographical metadata generated by a machine learning model, in accordance with an embodiment. Server infrastructure 102, bibliographical metadata generator 104, textual work storage 106, machine learning model 108, bibliographical metadata storage 110, library classification vocabulary 202, pre-processor 204, validator 206, metadata aggregator 212, embedding model 214, similarity model 216, and/or filter 218 may operate in accordance with flowchart 300. Note that not all steps of flowchart 300 may need to be performed in all embodiments, and in some embodiments, the steps of flowchart 300 may be performed in different orders than shown. Flowchart 300 is described as follows with respect to FIGS. 1-2 for illustrative purposes.

Flowchart 300 starts at step 302. In step 302, at least a portion of a textual work is provided to a machine learning model. For instance, pre-processor 204 obtains at least a portion of textual work 112 and provides the portion of textual work 112 in prompt 114 to machine learning model 108.

In step 304, a first summary of the textual work and a set of first subject headings associated with the textual work are received from the machine learning model. For instance, bibliographical metadata generator 104 receives first subject headings 116A and summary 116B from machine learning model 108. In embodiments, embedding model 214 receives first subject headings 116A from machine learning model 108, and generates first embedding vectors 224 representative of first subject headings 116A.

In step 306, a set of second subject headings are determined, the second subject headings satisfying a similarity threshold with the first subject headings. For instance, similarity model 216 determines second subject headings 226 associated with second embedding vectors 222 that satisfy a similarity threshold with first embedding vectors 224. In embodiments, similarity model 216 includes, but is not limited to, a clustering model, an ANN model, a k-NN model, and/or the like that maps first subject headings 116A to standardized subject headings based on a distance between first embedding vectors 224 and one or more second embedding vectors 222.

In step 308, the set of second subject headings are ranked based on the first summary. For instance, filter 218 ranks second subject headings 226 based on summary 116B. In embodiments, filter 218 ranks second subject headings 226 based on summary 116B by providing a follow-up prompt (not shown) along with second subject headings 226 to machine learning model 108 requesting a ranking of second subject headings 226 based on summary 116B previously provided by machine learning model 108. In embodiments, the follow-up prompt also incorporates summary 116B in the prompt itself.

In step 310, a subset of the second subject headings satisfying a rank threshold are determined. For instance, filter 218 determines the highest ranking second subject headings 226 as filtered subject headings 228. In embodiments, the highest ranking subject headings includes a predetermined number of the highest ranking second subject headings 226, such as, but not limited to, the top n subject headings, where n is any positive integer.

In step 312, bibliographical metadata is generated based at least on the subset of second subject headings. For instance, metadata generator 212 generates output bibliographical metadata 118 based at least on filtered subject headings 228. In embodiments, output bibliographical metadata 118 satisfies a standardized bibliographical metadata format, such as, but not limited to, MARC, MARXML, and/or the like.

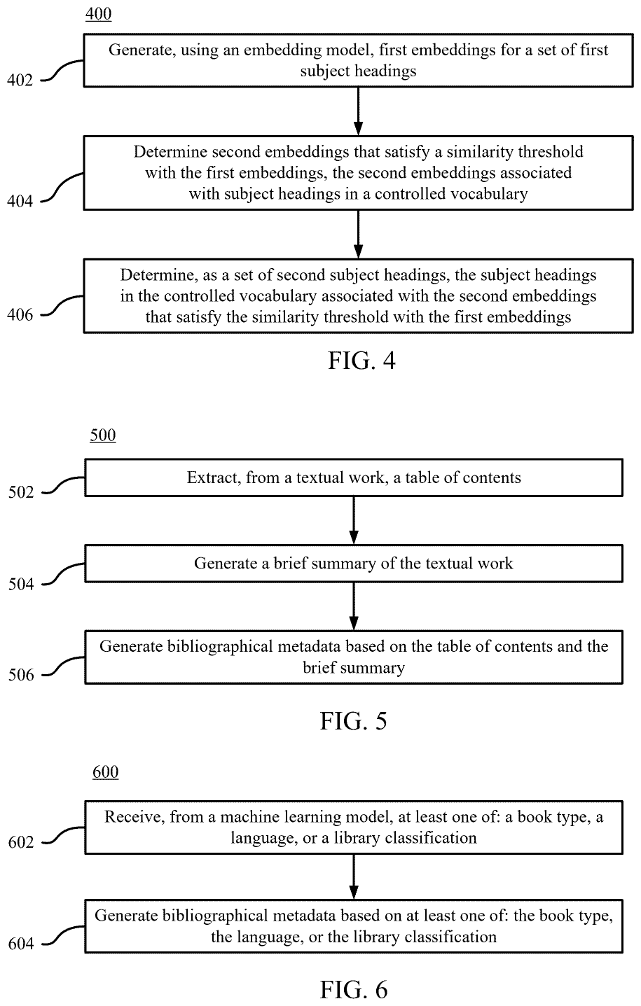

Embodiments described herein may operate in various ways to validate subject headings generated by a machine learning model. FIG. 4 depicts a flowchart 400 of a process for validating subject headings generated by a machine learning model, in accordance with an embodiment. Server infrastructure 102, bibliographical metadata generator 104, machine learning model 108, validator 206, embedding model 214, similarity model 216, and/or filter 218 may operate in accordance with flowchart 400. Note that not all steps of flowchart 400 may need to be performed in all embodiments, and in some embodiments, the steps of flowchart 400 may be performed in different orders than shown. Flowchart 400 is described as follows with respect to FIGS. 1-2 for illustrative purposes.

Flowchart 400 starts at step 402. In step 402, first embeddings are determined for a set of first subject headings. For instance, embedding model 214 generates first embedding vectors 224 representative of first subject headings 116A.

In step 404, second embeddings satisfying a similarity threshold with the first embeddings are determined, the second embeddings associated with subject headings in a controlled vocabulary. For instance, similarity model 216 determines second subject headings 226 associated with second embedding vectors 222 that satisfy a similarity threshold with first embedding vectors 224. In embodiments, second embedding vectors 222 are embedding vectors representative of standardized subject headings 220 in library classification vocabulary 202.

In step 406, the subject headings in the controlled vocabulary associated with the second embeddings that satisfy the similarity threshold with the first embeddings are determined as the set of second subject headings. For instance, similarity model 216 determines second subject headings 226 associated with second embedding vectors 222 that satisfy a similarity threshold with first embedding vectors 224. In embodiments, similarity model 216 includes, but is not limited to, a clustering model, an ANN model, a k-NN model, and/or the like that maps first subject headings 116A to standardized subject headings based on a distance between first embedding vectors 224 and one or more second embedding vectors 222.

Embodiments described herein may operate in various ways to generate bibliographical metadata. FIG. 5 depicts a flowchart 500 of a process for generating bibliographical metadata, in accordance with an embodiment. Server infrastructure 102, bibliographical metadata generator 104, machine learning model 108, pre-processor 204, table of contents extractor 208, post-processor 210, and/or metadata aggregator 212 may operate in accordance with flowchart 500. Note that not all steps of flowchart 500 may need to be performed in all embodiments, and in some embodiments, the steps of flowchart 500 may be performed in different orders than shown. Flowchart 500 is described as follows with respect to FIGS. 1-2 for illustrative purposes.

Flowchart 500 starts at step 502. In step 502, a table of contents is extracted from a textual work. For instance, table of contents extractor 208 extracts table of contents 234 from a portion 232 of textual work 112.

In step 504, a brief summary of the textual work is generated. For instance, post-processor 210 generates a brief summary 230 of summary 116B provided by machine learning model 108.

In step 506, bibliographical metadata is generated based on the table of contents and the brief summary. For instance, metadata generator 212 generates output bibliographical metadata 118 based at least on table of contents 234 and brief summary 230. In embodiments, output bibliographical metadata 118 satisfies a standardized bibliographical metadata format, such as, but not limited to, MARC, MARXML, and/or the like.

Embodiments described herein may operate in various ways to generate bibliographical metadata. FIG. 6 depicts a flowchart 600 of a process for generating bibliographical metadata, in accordance with an embodiment. Server infrastructure 102, bibliographical metadata generator 104, machine learning model 108, pre-processor 204, and/or metadata aggregator 212 may operate in accordance with flowchart 600. Flowchart 600 is described as follows with respect to FIGS. 1-2 for illustrative purposes.

Flowchart 600 starts at step 602. In step 602, at least one of a book type, a language, or a library classification is received from a machine learning model. For instance, metadata aggregator 212 receives, from machine learning model, bibliographical metadata 116C, including, but not limited to, a book type (e.g., fiction, non-fiction, genre, etc.), a language, a DDC, a LCC, and/or the like.

In step 604, bibliographical metadata is generated based on at least one of the book type, the language, or the library classification. For instance, metadata generator 212 generates output bibliographical metadata 118 based at least one or more of bibliographical metadata 116C. In embodiments, output bibliographical metadata 118 satisfies a standardized bibliographical metadata format, such as, but not limited to, MARC, MARXML, and/or the like.

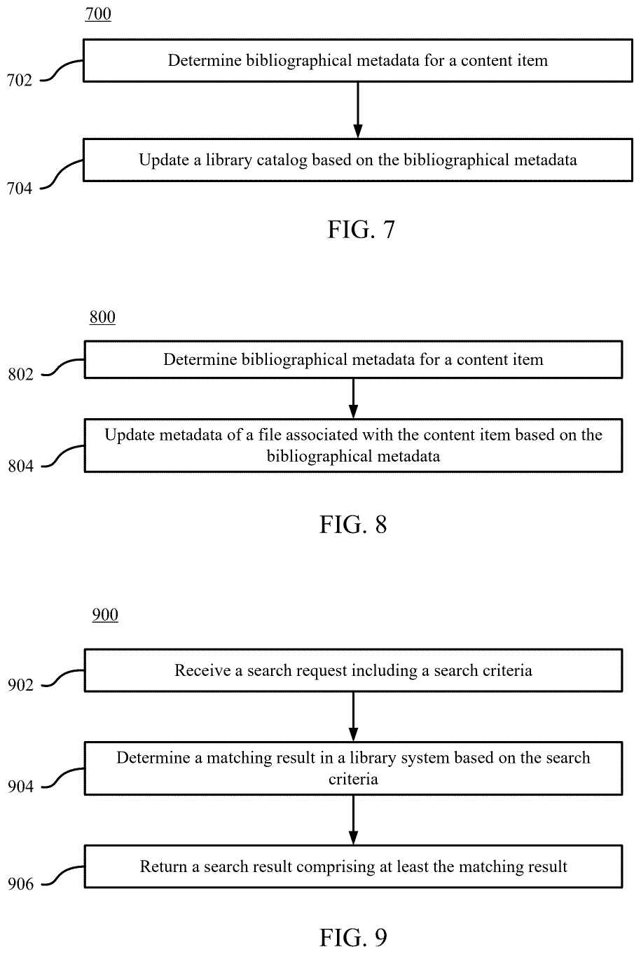

Embodiments described herein may operate in various ways to update a library catalog. For instance, FIG. 7 depicts a flowchart 700 of a process for updating a library catalog, in accordance with an embodiment. Server infrastructure 102, bibliographical metadata generator 104, machine learning model 108, pre-processor 204, table of contents extractor 208, post-processor 210, and/or metadata aggregator 212 may operate in accordance with flowchart 700. Note that not all steps of flowchart 700 may need to be performed in all embodiments, and in some embodiments, the steps of flowchart 700 may be performed in different orders than shown. Flowchart 700 is described as follows with respect to FIGS. 1-2 for illustrative purposes.

Flowchart 700 starts at step 702. In step 702, bibliographical metadata is determined for a content item. For instance, bibliographical metadata generator 104 generates output bibliographical metadata 118 for textual work 112. In instances, bibliographical metadata is determined based on the process set forth in flowchart 300 as described above.

In step 704, a library catalog is updated based on the bibliographical metadata. For instance, bibliographical metadata generator 104 updates a library catalog (e.g., bibliographical metadata storage 110) by updating a record associated with textual work 112 and/or creating a new record for textual work 112 with output bibliographical metadata 118. Updating the library catalog with output bibliographical metadata 118 improves the searchability of textual work 112 within the library system, and ensures compliance with library cataloging standards.

Embodiments described herein may operate in various ways to incorporate bibliographical metadata in a content file. For instance, FIG. 8 depicts a flowchart 800 of a process for incorporating bibliographical metadata in a content file, in accordance with an embodiment. Server infrastructure 102, bibliographical metadata generator 104, machine learning model 108, pre-processor 204, table of contents extractor 208, post-processor 210, and/or metadata aggregator 212 may operate in accordance with flowchart 800. Note that not all steps of flowchart 800 may need to be performed in all embodiments, and in some embodiments, the steps of flowchart 800 may be performed in different orders than shown. Flowchart 800 is described as follows with respect to FIGS. 1-2 for illustrative purposes.

Flowchart 800 starts at step 802. In step 802, bibliographical metadata is determined for a content item. For instance, bibliographical metadata generator 104 generates output bibliographical metadata 118 for textual work 112. In instances, bibliographical metadata is determined based on the process set forth in flowchart 300 as described above.

In step 804, metadata of a file associated with the content item based on the bibliographical metadata. For instance, bibliographical metadata generator 104 updates a file (e.g., text document, ebook file, etc.) associated with textual work 112 based on output bibliographical metadata 118.

Embodiments described herein may operate in various ways to perform a search based on bibliographical metadata. For instance, FIG. 9 depicts a flowchart 900 of a process for performing a search based on bibliographical metadata, in accordance with an embodiment. Server infrastructure 102, and/or search processor 120 may operate in accordance with flowchart 900. Note that not all steps of flowchart 900 may need to be performed in all embodiments, and in some embodiments, the steps of flowchart 900 may be performed in different orders than shown. Flowchart 900 is described as follows with respect to FIGS. 1-2 for illustrative purposes.

Flowchart 900 starts at step 902. In step 902, a search request including a search criteria is received. For instance, search processor 120 receives search request 120 that includes a search criteria, such as, but not limited to, a search string, a regular expression, a metadata field, a metadata value, and/or the like.

In step 904, a matching result is determined in a library system based on the search criteria. For instance, search processor 120 performs a search 124 against bibliographical metadata storage 110 and/or a search 126 against textual work storage 106 to determine a content item that satisfies the search criteria by, for example, by not limited to, determining a matching record that includes a bibliographical metadata field that satisfies the search criteria, determining record that includes text that satisfies the search criteria, determining a file that includes bibliographical metadata that satisfies the search criteria, and/or the like.

In step 906, a search result is returned comprising at least the matching result. For instance, search processor 120 returns search result 128 that contains a matching record from bibliographic metadata storage 110 and/or a matching file from textual work storage 106.

### III. Example Mobile Device and Computer System Implementation

The systems and methods described above in reference to FIGS. 1-9, including server infrastructure 102, bibliographical metadata generator 104, textual work storage 106, machine learning model 108, bibliographical metadata storage 110, search performer 120, library classification vocabulary 202, pre-processor 204, validator 206, table of contents extractor 208, post-processor 210, metadata aggregator 212, embedding model 214, similarity model 216, filter 218, and/or each of the components described therein, and/or the steps of flowcharts 300, 400, 500, and 600 may be implemented in hardware, or hardware combined with one or both of software and/or firmware. For example, server infrastructure 102, bibliographical metadata generator 104, textual work storage 106, machine learning model 108, bibliographical metadata storage 110, search performer 120, library classification vocabulary 202, pre-processor 204, validator 206, table of contents extractor 208, post-processor 210, metadata aggregator 212, embedding model 214, similarity model 216, filter 218, and/or each of the components described therein, and/or the steps of flowcharts 300, 400, 500, and/or 600 may be each implemented as computer program code/instructions configured to be executed in one or more processors and stored in a computer readable storage medium. Alternatively, server infrastructure 102, bibliographical metadata generator 104, textual work storage 106, machine learning model 108, bibliographical metadata storage 110, search performer 120, library classification vocabulary 202, pre-processor 204, validator 206, table of contents extractor 208, post-processor 210, metadata aggregator 212, embedding model 214, similarity model 216, filter 218, and/or each of the components described therein, and/or the steps of flowcharts 300, 400, 500, and/or 600 may be each implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 10. FIG. 10 shows a block diagram of an exemplary computing environment 1000 that includes a computing device 1002. Computing device 1002 is an example of bibliographical metadata generator 104 and/or machine learning model 108, which may each include one or more of the components of computing device 1002. In some embodiments, computing device 1002 is communicatively coupled with devices (not shown in FIG. 10) external to computing environment 1000 via network 1004. Network 1004 comprises one or more networks such as local area networks (LANs), wide area networks (WANs), enterprise networks, the Internet, etc., and may include one or more wired and/or wireless portions. Network 1004 may additionally or alternatively include a cellular network for cellular communications. Computing device 1002 is described in detail as follows.

Computing device 1002 can be any of a variety of types of computing devices. For example, computing device 1002 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. Computing device 1002 may alternatively be a stationary computing device such as a desktop computer, a personal computer (PC), a stationary server device, a minicomputer, a mainframe, a supercomputer, etc.

As shown in FIG. 10, computing device 1002 includes a variety of hardware and software components, including a processor 1010, a storage 1020, one or more input devices 1050, one or more output devices 1050, one or more wireless modems f0, one or more wired interfaces 1060, a power supply 1062, a location information (LI) receiver 1064, and an accelerometer 1066. Storage 1020 includes memory 1056, which includes non-removable memory 1022 and removable memory 1024, and a storage device 1090. Storage 1020 also stores an operating system 1012, application programs 1014, and application data 1016. Wireless modem(s) 1060 include a Wi-Fi modem 1062, a Bluetooth modem 1064, and a cellular modem 1066. Output device(s) 1050 includes a speaker 1052 and a display 1054. Input device(s) 1050 includes a touch screen 1052, a microphone 1054, a camera 1056, a physical keyboard 1058, and a trackball 1040. Not all components of computing device 1002 shown in FIG. 10 are present in all embodiments, additional components not shown may be present, and any combination of the components may be present in a particular embodiment. These components of computing device 1002 are described as follows.

A single processor 1010 (e.g., central processing unit (CPU), microcontroller, a microprocessor, signal processor, ASIC (application specific integrated circuit), and/or other physical hardware processor circuit) or multiple processors 1010 may be present in computing device 1002 for performing such tasks as program execution, signal coding, data processing, input/output processing, power control, and/or other functions. Processor 1010 may be a single-core or multi-core processor, and each processor core may be single-threaded or multithreaded (to provide multiple threads of execution concurrently). Processor 1010 is configured to execute program code stored in a computer readable medium, such as program code of operating system 1012 and application programs 1014 stored in storage 1020. The program code is structured to cause processor 1010 to perform operations, including the processes/methods disclosed herein. Operating system 1012 controls the allocation and usage of the components of computing device 1002 and provides support for one or more application programs 1014 (also referred to as “applications” or “apps”). Application programs 1014 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 1010 may include one or more general processors (e.g., CPUs) configured with or coupled to one or more hardware accelerators, such as one or more NPUs and/or one or more GPUs.

Any component in computing device 1002 can communicate with any other component according to function, although not all connections are shown for case of illustration. For instance, as shown in FIG. 10, bus 1006 is a multiple signal line communication medium (e.g., conductive traces in silicon, metal traces along a motherboard, wires, etc.) that may be present to communicatively couple processor 1010 to various other components of computing device 1002, although in other embodiments, an alternative bus, further buses, and/or one or more individual signal lines may be present to communicatively couple components. Bus 1006 represents one or more of any of several types of bus structures, including a memory bus or memory controller, a peripheral bus, an accelerated graphics port, and a processor or local bus using any of a variety of bus architectures.

Storage 1020 is physical storage that includes one or both of memory 1056 and storage device 1090, which store operating system 1012, application programs 1014, and application data 1016 according to any distribution. Non-removable memory 1022 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1022 may include main memory and may be separate from or fabricated in a same integrated circuit as processor 1010. As shown in FIG. 10, non-removable memory 1022 stores firmware 1018, which may be present to provide low-level control of hardware. Examples of firmware 1018 include BIOS (Basic Input/Output System, such as on personal computers) and boot firmware (e.g., on smart phones). Removable memory 1024 may be inserted into a receptacle of or otherwise coupled to computing device 1002 and can be removed by a user from computing device 1002. Removable memory 1024 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1090 may be present that are internal and/or external to a housing of computing device 1002 and may or may not be removable. Examples of storage device 1090 include a hard disk drive, a SSD, a thumb drive (e.g., a USB (Universal Serial Bus) flash drive), or other physical storage device.

One or more programs may be stored in storage 1020. Such programs include operating system 1012, one or more application programs 1014, and other program modules and program data. Examples of such application programs may include, for example, computer program logic (e.g., computer program code/instructions) for implementing bibliographical metadata generator 104, textual work storage 106, machine learning model 108, bibliographical metadata storage 110, search processor 120, library classification vocabulary 202, pre-processor 204, validator 206, table of contents extractor 208, post-processor 210, metadata aggregator 212, embedding model 214, similarity model 216, filter 218, and/or each of the components described therein, as well as any of flowcharts 300, 400, 500, and/or 600, and/or any individual steps thereof.

Storage 1020 also stores data used and/or generated by operating system 1012 and application programs 1014 as application data 1016. Examples of application data 1016 include web pages, text, images, tables, sound files, video data, and other data, which may also be sent to and/or received from one or more network servers or other devices via one or more wired or wireless networks. Storage 1020 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1002 through one or more input devices 1050 and may receive information from computing device 1002 through one or more output devices 1050. Input device(s) 1050 may include one or more of touch screen 1052, microphone 1054, camera 1056, physical keyboard 1058 and/or trackball 1040 and output device(s) 1050 may include one or more of speaker 1052 and display 1054. Each of input device(s) 1050 and output device(s) 1050 may be integral to computing device 1002 (e.g., built into a housing of computing device 1002) or external to computing device 1002 (e.g., communicatively coupled wired or wirelessly to computing device 1002 via wired interface(s) 1060 and/or wireless modem(s) 1060). Further input devices 1050 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1054 may display information, as well as operating as touch screen 1052 by receiving user commands and/or other information (e.g., by touch, finger gestures, virtual keyboard, etc.) as a user interface. Any number of each type of input device(s) 1050 and output device(s) 1050 may be present, including multiple microphones 1054, multiple cameras 1056, multiple speakers 1052, and/or multiple displays 1054.

One or more wireless modems 1060 can be coupled to antenna(s) (not shown) of computing device 1002 and can support two-way communications between processor 1010 and devices external to computing device 1002 through network 1004, as would be understood to persons skilled in the relevant art(s). Wireless modem 1060 is shown generically and can include a cellular modem 1066 for communicating with one or more cellular networks, such as a GSM network for data and voice communications within a single cellular network, between cellular networks, or between the mobile device and a public switched telephone network (PSTN). Wireless modem 1060 may also or alternatively include other radio-based modem types, such as a Bluetooth modem 1064 (also referred to as a “Bluetooth device”) and/or Wi-Fi modem 1062 (also referred to as an “wireless adaptor”). Wi-Fi modem 1062 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1064 is configured to communicate with another Bluetooth-capable device according to the Bluetooth short-range wireless technology standard(s) such as IEEE 802.15.1 and/or managed by the Bluetooth Special Interest Group (SIG).

Computing device 1002 can further include power supply 1062, LI receiver 1064, accelerometer 1066, and/or one or more wired interfaces 1060. Example wired interfaces 1060 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1060 of computing device 1002 provide for wired connections between computing device 1002 and network 1004, or between computing device 1002 and one or more devices/peripherals when such devices/peripherals are external to computing device 1002 (e.g., a pointing device, display 1054, speaker 1052, camera 1056, physical keyboard 1058, etc.). Power supply 1062 is configured to supply power to each of the components of computing device 1002 and may receive power from a battery internal to computing device 1002, and/or from a power cord plugged into a power port of computing device 1002 (e.g., a USB port, an A/C power port). LI receiver 1064 may be used for location determination of computing device 1002 and may include a satellite navigation receiver such as a Global Positioning System (GPS) receiver or may include other type of location determiner configured to determine location of computing device 1002 based on received information (e.g., using cell tower triangulation, etc.). Accelerometer 1066 may be present to determine an orientation of computing device 1002.

Note that the illustrated components of computing device 1002 are not required or all-inclusive, and fewer or greater numbers of components may be present as would be recognized by one skilled in the art. For example, computing device 1002 may also include one or more of a gyroscope, barometer, proximity sensor, ambient light sensor, digital compass, etc. Processor 1010 and memory 1056 may be co-located in a same semiconductor device package, such as being included together in an integrated circuit chip, FPGA, or system-on-chip (SOC), optionally along with further components of computing device 1002.

In embodiments, computing device 1002 is configured to implement any of the above-described features of flowcharts herein. Computer program logic for performing any of the operations, steps, and/or functions described herein may be stored in storage 1020 and executed by processor 1010.

In some embodiments, server infrastructure 1070 may be present in computing environment 1000 and may be communicatively coupled with computing device 1002 via network 1004. Server infrastructure 1070, when present, may be a network-accessible server set (e.g., a cloud-based environment or platform). As shown in FIG. 10, server infrastructure 1070 includes clusters 1072. Each of clusters 1072 may comprise a group of one or more compute nodes and/or a group of one or more storage nodes. For example, as shown in FIG. 10, cluster 1072 includes nodes 1074. Each of nodes 1074 are accessible via network 1004 (e.g., in a “cloud-based” embodiment) to build, deploy, and manage applications and services. Any of nodes 1074 may be a storage node that comprises a plurality of physical storage disks, SSDs, and/or other physical storage devices that are accessible via network 1004 and are configured to store data associated with the applications and services managed by nodes 1074. For example, as shown in FIG. 10, nodes 1074 may store application data 1078.

Each of nodes 1074 may, as a compute node, comprise one or more server computers, server systems, and/or computing devices. For instance, a node 1074 may include one or more of the components of computing device 1002 disclosed herein. Each of nodes 1074 may be configured to execute one or more software applications (or “applications”) and/or services and/or manage hardware resources (e.g., processors, memory, etc.), which may be utilized by users (e.g., customers) of the network-accessible server set. For example, as shown in FIG. 10, nodes 1074 may operate application programs 1076. In an implementation, a node of nodes 1074 may operate or comprise one or more virtual machines, with each virtual machine emulating a system architecture (e.g., an operating system), in an isolated manner, upon which applications such as application programs 1076 may be executed.

In an embodiment, one or more of clusters 1072 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1072 may be a datacenter in a distributed collection of datacenters. In embodiments, exemplary computing environment 1000 comprises part of a cloud-based platform.

In an embodiment, computing device 1002 may access application programs 1076 for execution in any manner, such as by a client application and/or a browser at computing device 1002.

For purposes of network (e.g., cloud) backup and data security, computing device 1002 may additionally and/or alternatively synchronize copies of application programs 1014 and/or application data 1016 to be stored at network-based server infrastructure 1070 as application programs 1076 and/or application data 1078. For instance, operating system 1012 and/or application programs 1014 may include a file hosting service client configured to synchronize applications and/or data stored in storage 1020 at network-based server infrastructure 1070.

In some embodiments, on-premises servers 1092 may be present in computing environment 1000 and may be communicatively coupled with computing device 1002 via network 1004. On-premises servers 1092, when present, are hosted within an organization's infrastructure and, in many cases, physically onsite of a facility of that organization. On-premises servers 1092 are controlled, administered, and maintained by IT (Information Technology) personnel of the organization or an IT partner to the organization. Application data 1098 may be shared by on-premises servers 1092 between computing devices of the organization, including computing device 1002 (when part of an organization) through a local network of the organization, and/or through further networks accessible to the organization (including the Internet). Furthermore, on-premises servers 1092 may serve applications such as application programs 1096 to the computing devices of the organization, including computing device 1002. Accordingly, on-premises servers 1092 may include storage 1094 (which includes one or more physical storage devices such as storage disks and/or SSDs) for storage of application programs 1096 and application data 1098 and may include one or more processors for execution of application programs 1096. Still further, computing device 1002 may be configured to synchronize copies of application programs 1014 and/or application data 1016 for backup storage at on-premises servers 1092 as application programs 1096 and/or application data 1098.

Embodiments described herein may be implemented in one or more of computing device 1002, network-based server infrastructure 1070, and on-premises servers 1092. For example, in some embodiments, computing device 1002 may be used to implement systems, clients, or devices, or components/subcomponents thereof, disclosed elsewhere herein. In other embodiments, a combination of computing device 1002, network-based server infrastructure 1070, and/or on-premises servers 1092 may be used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1020. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1014) may be stored in storage 1020. Such computer programs may also be received via wired interface(s) 1060 and/or wireless modem(s) 1060 over network 1004. Such computer programs, when executed or loaded by an application, enable computing device 1002 to implement features of embodiments discussed herein. Accordingly, such computer programs represent controllers of the computing device 1002.

Embodiments are also directed to computer program products comprising computer code or instructions stored on any computer-readable medium or computer-readable storage medium. Such computer program products include the physical storage of storage 1020 as well as further physical storage types.

### IV. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system comprising:
a processor; and
a memory device comprising program code structured to cause the processor to:
provide, to a machine learning model, at least a portion of a textual work;
receive, from the machine learning model, a first summary of the textual work and a set of first subject headings associated with a subject of the textual work;
determine a set of second subject headings that satisfy a similarity threshold with the first subject headings;
rank the set of second subject headings based on the first summary;
determine a subset of second subject headings that satisfy a rank threshold; and
generate bibliographical metadata based at least on the subset of second subject headings.

2. The system of claim 1, wherein, to determine a set of second subject headings that satisfy a similarity threshold with the first subject headings, the program code is structured to cause the processor to:
generate, using an embedding model, first embeddings for the set of first subject headings;
determine second embeddings that satisfy the similarity threshold with the first embeddings, the second embeddings associated with subject headings in a controlled vocabulary; and
determine, as the set of second subject headings, the subject headings in the controlled vocabulary associated with the second embeddings that satisfy the similarity threshold with the first embeddings.

3. The system of claim 2, wherein the controlled vocabulary comprises at least one of:
a subject classification system; or
the Library of Congress Subject Headings (LCSH).

4. The system of claim 2, wherein, to determine second embeddings that satisfy the similarity threshold with the first embeddings, the program code is structured to cause the processor to:
provide the first embeddings and the second embeddings to a similarity model, the similarity model comprising at least one of:
a k-nearest neighbor (k-NN) model; or
an approximate nearest neighbor (ANN) model.

5. The system of claim 1, wherein, to provide, to a machine learning model, at least a portion of a textual work, the program code is structured to cause the processor to:
provide, to a large language model (LLM), a portion of the textual work of a predetermined length.

6. The system of claim 1, wherein, to generate the bibliographical metadata, the program code is structured to cause the processor to:
extract, from the textual work, a table of contents;
generate, based on the first summary, a brief summary of the textual work; and
generate the bibliographical metadata further based on the table of contents and the brief summary.

7. The system of claim 1, wherein, to generate the bibliographical metadata, the program code is structured to cause the processor to:
receive, from the machine learning model, at least one of: a book type, a language, or a library classification; and
generate the bibliographical metadata further based on at least one of: the book type, the language, or the library classification.

8. A method comprising:
providing, to a machine learning model, at least a portion of a textual work;
receiving, from the machine learning model, a first summary of the textual work and a set of first subject headings associated with a subject of the textual work;
determining a set of second subject headings that satisfy a similarity threshold with the first subject headings;
ranking the set of second subject headings based on the first summary;
determining a subset of second subject headings that satisfy a rank threshold; and
generating bibliographical metadata based at least on the subset of second subject headings.

9. The method of claim 8, wherein said determining a set of second subject headings that satisfy a similarity threshold with the first subject headings comprises:
generating, using an embedding model, first embeddings for the set of first subject headings;
determining second embeddings that satisfy the similarity threshold with the first embeddings, the second embeddings associated with subject headings in a controlled vocabulary; and
determining, as the set of second subject headings, the subject headings in the controlled vocabulary associated with the second embeddings that satisfy the similarity threshold with the first embeddings.

10. The method of claim 9, wherein the controlled vocabulary comprises at least one of:
a subject classification system; or
the Library of Congress Subject Headings (LCSH).

11. The method of claim 9, wherein said determining second embeddings that satisfy the similarity threshold with the first embeddings comprises:
providing the first embeddings and the second embeddings to a similarity model, the similarity model comprising at least one of:
a k-nearest neighbor (k-NN) model; or
an approximate nearest neighbor (ANN) model.

12. The method of claim 8, wherein said providing, to a machine learning model, at least a portion of a textual work comprises:
providing, to a large language model (LLM), a portion of the textual work of a predetermined length.

13. The method of claim 8, wherein said generating the bibliographical metadata comprises:
extracting, from the textual work, a table of contents;
generating, based on the first summary, a brief summary of the textual work; and
generating the bibliographical metadata further based on the table of contents and the brief summary.

14. The method of claim 8, wherein said generating the bibliographical metadata comprises:
receiving, from the machine learning model, at least one of: a book type, a language, or a library classification; and
generating the bibliographical metadata further based on at least one of: the book type, the language, or the library classification.

15. A computer-readable storage medium comprising executable instructions, that when executed by a processor, cause the processor to:
provide, to a machine learning model, at least a portion of a textual work;
receive, from the machine learning model, a first summary of the textual work and a set of first subject headings associated with a subject of the textual work;
determine a set of second subject headings that satisfy a similarity threshold with the first subject headings;
rank the set of second subject headings based on the first summary;
determine a subset of second subject headings that satisfy a rank threshold; and
generate bibliographical metadata based at least on the subset of second subject headings.

16. The computer-readable storage medium of claim 15, wherein, to determine a set of second subject headings that satisfy a similarity threshold with the first subject headings, the executable instructions, when executed by the processor, cause the processor to:
generate, using an embedding model, first embeddings for the set of first subject headings;
determine second embeddings that satisfy the similarity threshold with the first embeddings, the second embeddings associated with subject headings in a controlled vocabulary; and
determine, as the set of second subject headings, the subject headings in the controlled vocabulary associated with the second embeddings that satisfy the similarity threshold with the first embeddings.

17. The computer-readable storage medium of claim 16, wherein the controlled vocabulary comprises at least one of:
a subject classification system; or
the Library of Congress Subject Headings (LCSH).

18. The computer-readable storage medium of claim 16, wherein, to determine second embeddings that satisfy the similarity threshold with the first embeddings, executable instructions, when executed by the processor, cause the processor to:
provide the first embeddings and the second embeddings to a similarity model, the similarity model comprising at least one of:
a k-nearest neighbor (k-NN) model; or
an approximate nearest neighbor (ANN) model.

19. The computer-readable storage medium of claim 15, wherein, to provide, to a machine learning model, at least a portion of a textual work, the executable instructions, when executed by the processor, cause the processor to:
provide, to a large language model (LLM), a portion of the textual work of a predetermined length.

20. The computer-readable storage medium of claim 15, wherein, to generate the bibliographical metadata, the executable instructions, when executed by the processor, cause the processor to:
extract, from the textual work, a table of contents;
generate, based on the first summary, a brief summary of the textual work; and
generate the bibliographical metadata further based on the table of contents and the brief summary.
